(19) United States
(12) Patent Application Publication
(10) Pub. No.: US 2021/0114862 A1
(43) Pub. Date: Apr. 22, 2021

(54) EQUINE SENSOR HEADBAND

(71) Applicant: Farm Jenny LLC, Mars, PA (US)

(72) Inventors: L. Robert Crouthamel, Mars, PA (US); Tammy L. Crouthamel, Mars, PA (US); Jennifer Rocket, Pittsburgh, PA (US)

(21) Appl. No.: 17/074,959

(22) Filed: Oct. 20, 2020

Related U.S. Application Data
(60) Provisional application No. 62/923,731, filed on Oct. 21, 2019.

(51) Int. Cl. B68B 1/02; A01K 29/00

(52) U.S. Cl. CPC B68B 1/02; A01K 29/005

(57) ABSTRACT

A headband comprising a fabric portion whose position is constrained at a trailing edge of a jaw of a horse by a nose strap resting on the face of the horse between the eyes and muzzle and a tag positioned by the headband on a head of the horse, avoiding a forelock and at least one ear of the horse, wherein a tension in a nosepiece portion of the headband is translated to a tension in a head portion of the headband which serves to pull the tag into contact with the head just behind a poll.

### CLAIM TO PRIORITY

This application claims the benefit of the following provisional applications, each of which is hereby incorporated by reference in its entirety: U.S. Provisional Patent Application No. 62/923,731, filed Oct. 21, 2019 (FJEN-0005-P01).

### BACKGROUND

### Field

A mechanism for affixing a wireless sensor to an animal is disclosed.

### Description of the Related Art

In embodiments, various solutions are presented to securely position a monitoring wireless sensor, or Tag, in a manner which is significantly and consistently coupled to the position and movement of a wide variety of equids (‘horse’ herein) and other animals, also providing a clear RF path to the surrounding environment in most directions, while preserving animal comfort and safety.

Advances in sensing technology have allowed a compact electronic device (e.g. Tag) when fitted with any of a variety of sensors (motion, location, temperature, magnetic field, light, sound, etc.), to identify, record, and transmit animal behavioral observations. These Tags may be worn continuously by the animal of interest.

Such Tags may be used, for example, to monitor the rumination patterns of dairy cattle or listen for the squeal of a newborn pig when the mother sow rolls onto it. Behavioral observations in horses would, for example, allow for early detection of illness or injury.

Animals display a wide variety of conditions through movement of their heads: head down during grazing, head bobbing during walking, head shaking for flies, biting at side for gastric pain, and the like. This makes the head an attractive location for mounting a Tag. The head also represents an attractive mounting location for a Tag due to its height off the ground and relatively unobstructed RF path to the surrounding environment.

Tags on many animals, such as cattle, sheep, goats, chickens, fowl, may be readily affixed using tags pierced through the animals' ear or wing. Horses, whose visual appearance is highly prized, are not typically fitted with ear piercings, ruling out this method.

A Tag for an animal's head, such as a horse's head, needs to be securely mounted such that it is consistently coupled to the animal's motion, while not negatively impacting the animal's comfort and not posing a hazard to the animal including entanglement.

A variety of accessories are used on or around a horse's head for various purposes, but none of these devices meet the particular needs for affixing a Tag intended to continuously monitor the animal's condition or behavior. For example, for rider and handler control, horses commonly are fitted with a halter or bridle. A bridle is generally used by a person who is riding or driving an animal that has been trained in this use. Most bridles include a bit in the horse's mouth, but bitless bridles or ‘hackamore’ are also used and typically include a heavy nose band. A bridle offers more precise control than a halter. Bridles are often made of lighter materials, for cosmetic reasons, and may easily break. Bridles may not be worn continuously. For these reasons, a bridle is an unsuitable location for a Tag.

Referring to FIG. 1, a halter is primarily intended for use by a handler on the ground. Halters are designed to catch, hold, lead and tie animals. A halter typically includes a large ring under the front portion of the jaw, which is used to connect a rope or lead such that it provides significant leverage to control the animal's head position.

There are differing schools of thought regarding whether a horse should wear a halter when turned out to pasture or left in a stall. On the one hand, a horse with halter is easier to catch and lead in case of emergency (predator, fire, etc.), however, entrapment is a significant concern. Halters with an intentionally weak breakaway feature are recommended for 24/7 use, however, many horse owners insist that their animal never wear a halter unless under direct supervision. Some horse owners may refuse to wear a Tag on their horse continually if a halter is required.

Horse monitoring solutions may be embedded into the top strap of a halter and may measure cardiac rhythm and respiration rate using radar, which may be somewhat more forgiving of loose contact. Such a solution may be used overnight in a stall and may not be intended for continuous wear and operation.

For the animal's protection and comfort, horses are also commonly fitted with masks of various sorts. These masks are most commonly used to exclude flying insects from the face and eyes but may also be used to protect eyes or sensitive skin from the sun. Such nets and masks date to the 1800s or earlier and have evolved to include, for example, domed mesh sections over the eyes and muzzle, closed sleeves covering the ears, and openings for the forelock. These ‘Fly Masks’ are relatively light weight, loose-fitting items, with most of the material projecting over the eyes and muzzle, though some models also cover the ears with closed-end sleeves. Some models have an opening for the forelock hair, which protrudes between the ears, again, to preserve the aesthetics of the animal.

Fly masks are widely tolerated by horses and owners. Their light weight and loose fit are comfortable for the horse. Construction is sufficiently lightweight as to pose little entrapment hazard. These benefits also make fly masks or similar construction poorly suited for a Tag mounting as the animal's motion is poorly coupled to the mask and positioning may not be consistent.

In certain cases, a horse will be fitted with a padded cap or soft helmet to protect the top of its head and skull, called the poll. This is particularly common during transport of the animal, because the ceiling of the trailer may be in close proximity. These helmets typically attach to an existing halter and are thick, semi-rigid construction. A helmet's poor fit and reliance on a halter make it ill-suited for continuous wear.

Referring now to FIG. 2, for visual identification, horses may be fit with a fabric or vinyl identification collar which is either directly imprinted or affixed with identification of the horse.

Fabric identification collars are typically fitted with a release (e.g., hook and loop fastener) link, whereas vinyl collars are typically secured with a metal buckle which also serves as a weight to consistently orient the collar around the neck. The thickness of vinyl collars is such that they will break if the horse becomes entangled.

Collars present a difficult mounting location for a horse Tag. Behavioral sensors have been successfully used on cows and cattle using neck-worn sensor collars with heavy counterweights that maintain the sensor's position at the top of the neck. Because of the highly tapered shape of a horse's neck, compared to cattle, a tag mounted to the top of a weighted collar would suffer from poor repeatability. The counterweight may also be problematic for such an athletic animal.

Finally, a wide variety of performance monitoring solutions are available for horses. These systems include a gait measurement system with temporary sensors for the horse's limbs. A variety of systems include motion sensor for the rider and saddle as a training aide. Several horse heart-rate monitoring systems are available with electrodes in elastic chest straps or embedded into the saddle girth. None of these systems are intended for continuous use, nor do they mount at the preferred head location.

In some cases, it is desirable for a Tag to be easily removable from the animal, for example to replace the Tag or its battery or move the Tag to a different animal or location.

Some animal monitoring systems monitor long-term trends in an animal's condition, behavior or environment. Consistent positioning and mechanical coupling of the Tag with the animal is important to the quality of the data collected.

For the reasons explained above, a new mechanism is needed to adequately, consistently and removably secure a Tag to an animal, such as a horse's, head.

### SUMMARY

An equine sensor headband is presented to securely position a Tag between the ears of a horse, just behind the poll. This headband may use minimal material and contact points to increase animal comfort and minimize entrapment hazards. The minimalist design may enable the headband to be worn under other common accessories such as halters, bridles, and fly masks without interference.

Tension may be maintained across the crown of the animal's head using a set of members (e.g. three or more) which serve to pull the Tag into contact with the skull without contacting the aesthetically prized forelock or causing animal comfort issues with the ears.

Tension in the Tag's suspension web may be derived from a bifurcated headband passing both in front of and behind the horse's ears. The rear member of the headband may be held in tension by a strap extending under and around the rear of the jawbone. The front member of the bifurcated headband may consist of one or more elastic elements which serve to maintain sufficient tension while passing in front of the forelock while adapting to a wide variety of animal sizes and head shapes.

Position and tension in the headband's jaw piece may be maintained by a diagonal strap passing over the animal's face, between the eyes and muzzle. This special nosepiece prevents the lower portion of the bifurcated headband from slipping back on the jaw towards the throat. In pulling the headband toward the larger circumference of the jaw, the nose strap creates tension in the headband. Elasticity in the nose strap ensures comfort while increasing the total compliance of the nose strap and headband system, thus maintaining adequate tension of the bifurcated headband over a wide variety of animal postures and movements.

The headband may include provisions for engaging the tag in a single orientation, ensuring consistent operation orientation with the animal's body.

The headband may include provisions for simultaneous interrogation of an RFID device embedded in the headband with a similar device in the Tag, for example to permit Tag-to-animal association and configuration.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts the prior art of a conventional horse halter which includes a substantially circular nose band (nosepiece) and lead attachment point at the narrow portion of the face. The second circular feature behind the ears serves primarily to prevent the nosepiece from falling off the end of the horse's muzzle and is connected with two or more cross-members, sometimes called cheekpieces.

FIG. 2 depicts the prior art of a horse identification collar, which fits on the neck below the throat.

FIG. 3 an embodiment of the headband whose position is constrained at the trailing edge of the jaw by a substantially elliptical nosepiece resting on the animal's face, between the eyes and muzzle.

FIG. 4 depicts an embodiment of the headband in profile, showing how tension in the nosepiece is translated to tension in the headband, and in turn serves to pull the Tag into contact with the animal's head, just behind the poll.

FIG. 5 depicts an embodiment of the headband from above, showing how the tension from the headband is translated to the Tag while avoiding the forelock and ears.

FIG. 6 depicts an embodiment of the headband with an example pattern for the headband top section, including a Tag pouch top section both with and without an RFID device embedded. Features to locate and retain the Tag in the correct orientation are shown.

FIGS. 7A and 7B depict embodiments of the headband with a cross-sectional view of the pouch top and Tag both with and without their respective RFID devices.

FIGS. 8A and 8B depict several views of an embodiment of the headband.

FIGS. 9A and 9B depict several views of an embodiment of the headband with a round tag.

FIGS. 10A, 10B 10C, 10D, 10E, 10F, and 10G depict several views of an embodiment of the tag.

FIG. 11 depicts a system for communicating data from the tag.

FIGS. 12A and 12B depict several views of an embodiment of the headband.

FIGS. 12C, 12D, and 12E depict several embodiments of connection elements.

### DETAILED DESCRIPTION

In recognition of differing objectives and constraints for a horse Tag, a different approach is taken than that employed in halters, bridles, fly masks and collars. The disclosed methods and systems work to significantly and consistently couple the position, condition and behavior of a wide variety of horses to an easily separable Tag, while providing a clear RF path to the surrounding environment in most directions and preserving animal comfort and safety.

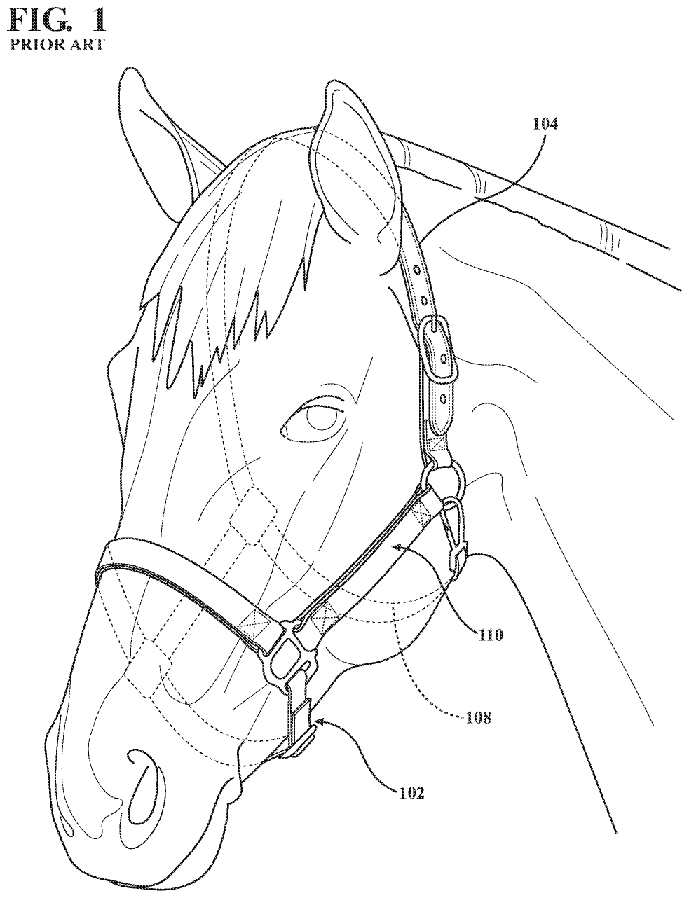

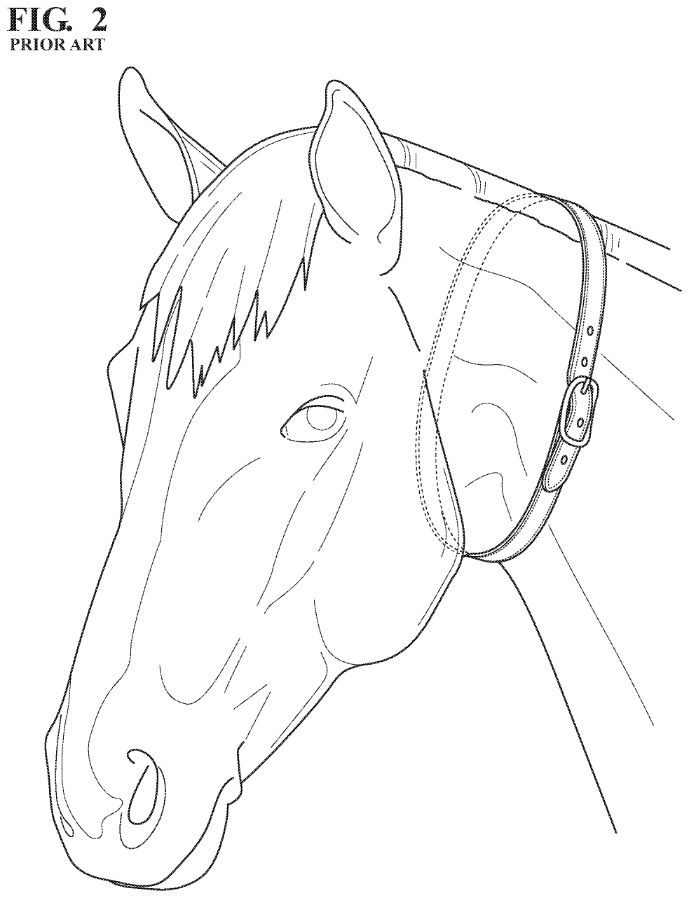

Referring to FIG. 1, a halter of the prior art includes two tied circular contacts, the noseband 102 and a rear circumference that encircles the horse's head on a first side 104 and a second side 108. The two circular contacts are connected by two cross-members 110, one on each side of the horse's face. In particular, the primary point of control for halters and bridles is the noseband 102. This position allows the handler some degree of leverage to rotate the horse's head in the desired direction. Portions of these devices wrapping behind the ears or around the back of the jaw serve only to prevent the noseband from slipping off the end of the animal's muzzle. In contrast, the embodiments described herein have no need to control the animal's movement and can forgo the tight fit around the narrow part of the face. In contrast, the embodiments described herein employ an elliptical nosepiece 304 passing diagonally across the face, between the eyes and muzzle, to maintain consistent tension in the headband member 312, also referred to herein as jaw piece 312, jaw member or elongated member, by constraining its movement toward the throat along the trailing edge of the jawbone.

The embodiments described herein is substantially different from prior art devices including fly masks, which seek to project protective layers (mesh, clear plastic, fringe) over a horse's eyes, face, and muzzle, much like a tent. While these prior art devices similarly locate around the ears and forelock 402, they do not require close contact in the region behind the poll 404 and between the ears. Further, these devices are typically more rigid than elastic and are mechanically constrained to the horse's head in much the same way as a conventional halter.

The embodiments described herein use minimal material and contact points to increase animal comfort and minimize entrapment hazards. Fitment is sufficiently different and unobtrusive so as to permit the embodiments to be worn under other common accessories such as halters, bridles, and fly masks without interference with the normal activities of the animal.

Certain terms are used throughout the description and the claims that, while for the most part are well known, may require some explanation. It should be understood that, as used herein:

The term “Animal” is understood to include farm animals, (including but not limited to horses, cows, cattle, swine, birds and fowl) and companion animals (cats, dogs, etc.).

The term Animal Tag, or “Tag” refers to a small, battery powered device, which includes a wireless transceiver and at least some sensing (e.g., position/motion, ambient temperature, animal temperature, pulse rate, respiration rate, etc.). A Tag may send and receive data from other parts of an animal monitoring system.

The term Horse, Equid or “Horse” refers to a member of the Equidae family of horses and related animals, including the horses, donkeys, mules, and zebras.

The term “Mount” refers to an item, including but not limited to a soft-goods article, flexible plastic or composite, leather article, which serves to fix a Tag in a particular location on an animal to be monitored so as to convey information about the animal's behavior, location, condition, or immediate environment via the sensing and communications elements of the Tag.

The term “Poll” refers to the part of an animal's head, immediately behind or right between the ears. In horses, “Poll” refers to the occipital protrusion at the back of the skull.

The term “RFID” refers to Radio-frequency identification (RFID). RFID uses electromagnetic fields to automatically transfer information between two objects. Typically consists of a passive “RFID tag” and an active “RFID Reader” or “RFID Reader/Writer”. RFID is understood to include devices operating at a wide variety of frequencies, including but not limited to Near-Field Communications (NFC) operating at 13.56 MHz.

Animal monitoring systems often include a Tag, affixed to the animal of interest. Tags may be affixed to the animal using a Mount. The present disclosure describes characteristics of one or more Mounts designed to affix a Tag to an animal, wherein the animal is most commonly a member of the family of equids, or simply “horse.”

In certain embodiments, it is desirable for the Tag to be easily separated from the Mount without removing the Mount from the animal. Reasons include, for example, for battery replacement or to move the Tag to another Mount used with the same animal, or to move the Tag to a different animal.

Mounts may be designed to provide a rugged attachment mechanism which is safe and comfortable for the animal and placement location.

Certain embodiments of the present disclosure include but are not limited to Mounts which include a memory device, with unique serial number, data of the animal, configuration information, and the like, readable using an RFID device (e.g., an RFID/NFC tag device).

Certain embodiments of the present disclosure include but are not limited to Tags which include a memory device, with unique serial number, data of the animal, configuration information, and the like, readable using an RFID device (e.g., an RFID/NFC tag device).

Certain embodiments of the present disclosure, such as the Tag and Mount, are similar to those described in US 2019/0380311 entitled “FARM ASSET TRACKING, MONITORING, AND ALERTS”, and filed Jun. 17, 2019 (FJEN-0002-U01), which has been incorporated by reference herein in its entirety.

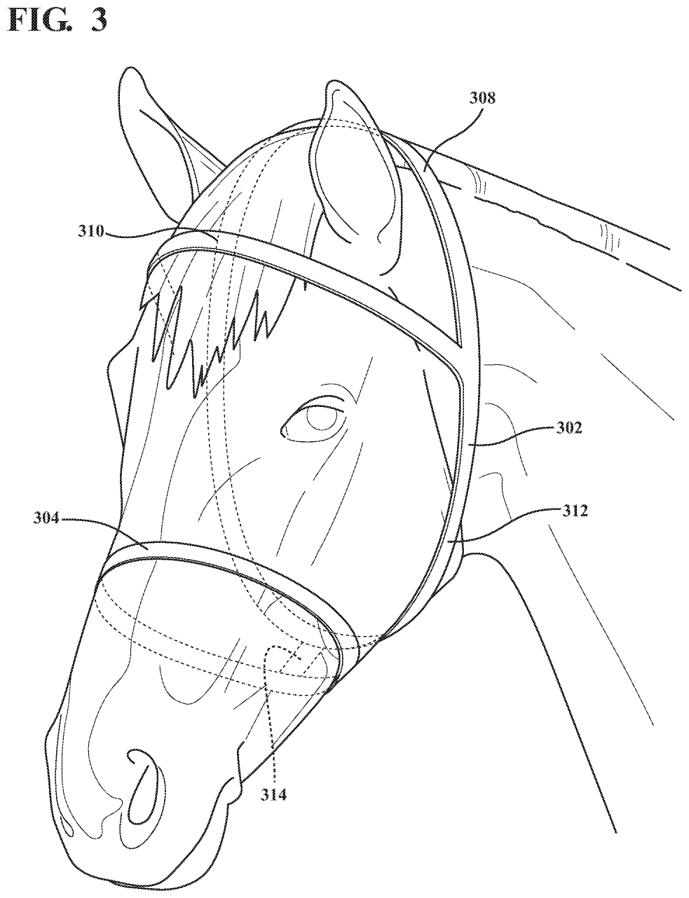

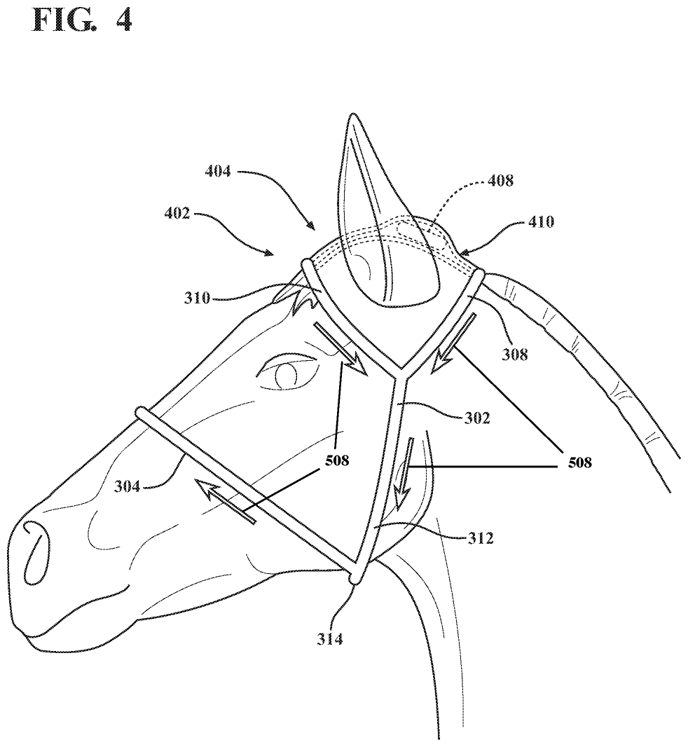

Referring now to FIG. 3 and FIG. 4, certain mounts may include an equine sensor headband 302. The equine sensor headband 302 securely positions a Tag 408 between the ears of a horse, just behind the Poll 404. FIG. 3 depicts an embodiment of the headband 302 whose position is constrained at the trailing edge of the jaw by a substantially elliptical nose piece 304 resting on the animal's face, between the eyes and muzzle. The headband 302 also includes a bifurcated headband with a front member 310 passing in front of the horse's ears and a rear member 308 passing behind the horse's ears, making up the head portion of the headband. The head portion of the headband may be held in tension by a jaw piece 312 extending under and around the rear of the jawbone, as shown by the tension arrows 508. The front member 310 of the bifurcated headband may consist of one or more elastic elements which serve to maintain sufficient tension while passing in front of the forelock 402 and while adapting to a wide variety of animal sizes and head shapes. Similarly, the rear member 308 may consist of one or more elastic elements which serve to maintain sufficient tension while passing behind the horse's ears and while adapting to a wide variety of animal sizes and head shapes. Position and tension in the headband's jaw piece 312 may be maintained by the diagonal nose strap 304 passing over the animal's face, between the eyes and muzzle, connected to the jaw piece 312 under the chin by a connection member 314. Elasticity in the nose strap 304 ensures comfort while increasing the total compliance of the nose strap 304 and headband 302 and while maintaining adequate tension of the bifurcated headband over a wide variety of animal postures and movements.

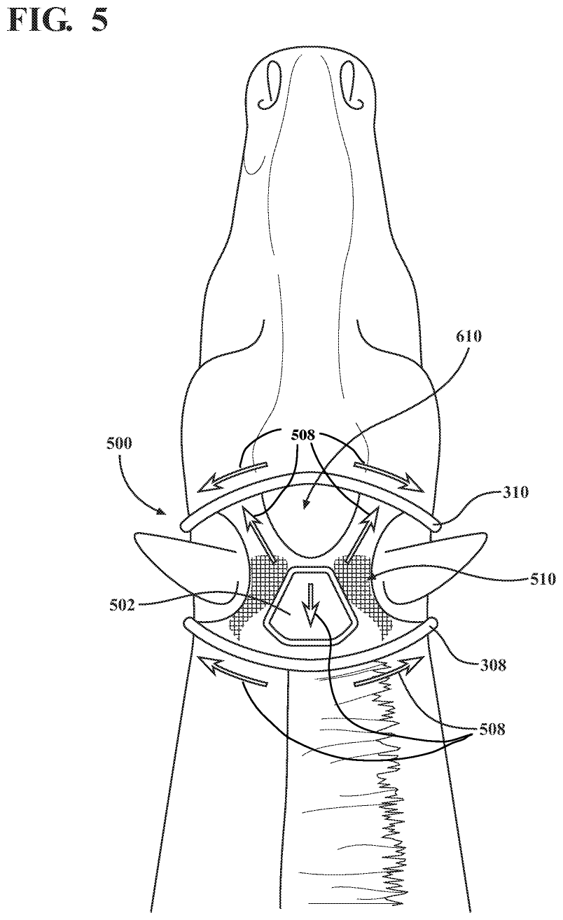

Referring to FIG. 4 and FIG. 5, the headband elastically suspends the Tag 502 between the horse's ears using members 308, 310, 510 which pull the Tag 502, as depicted by the tension arrows 508, into consistent contact with the animal's head, just behind the poll 404 while avoiding damage to the forelock hair or causing discomfort around the ears. This portion of the headband may be known as the tag suspension system 500. The Tag suspension system 500 may be pulled taut by the circular contact of the trailing edge of the headband, which sits around the back of the horse's head (e.g. the rear member 308) and the circular contact of the leading edge of the headband, which sits around horse's forehead (e.g. the front member 310). Members 308 and 310 are in turn pulled taut by the jaw piece 312 extending under the back edge of the jawbone. By itself, the system of 500, 308, 310 and 312, while secured around the horse's head, may not maintain this position as tension in these elements translates into a rearward force vector as the jaw piece 312 attempts to slide back toward the animal's throat. Position of the jaw piece 312 near the widest part of the jaw may be maintained by a counteracting force from the nose piece 304, ensuring tension is maintained in the headband system.

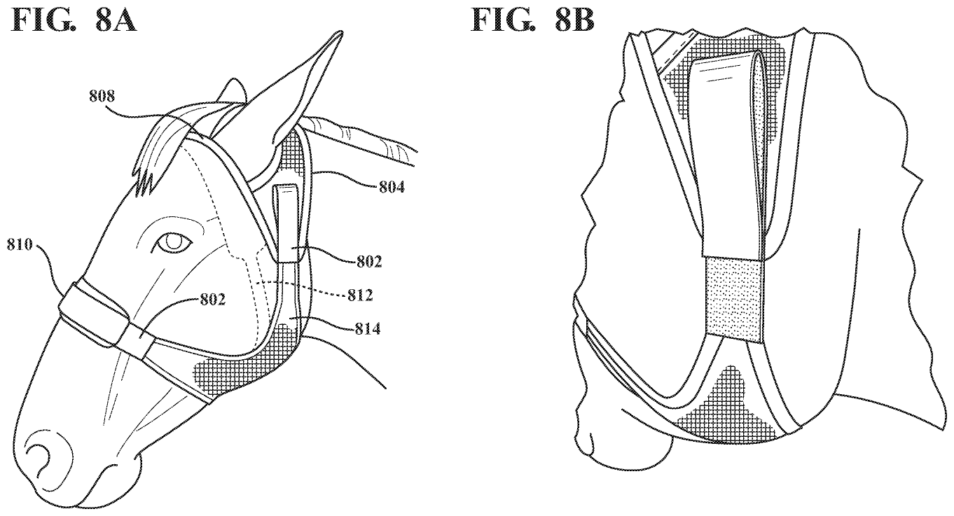

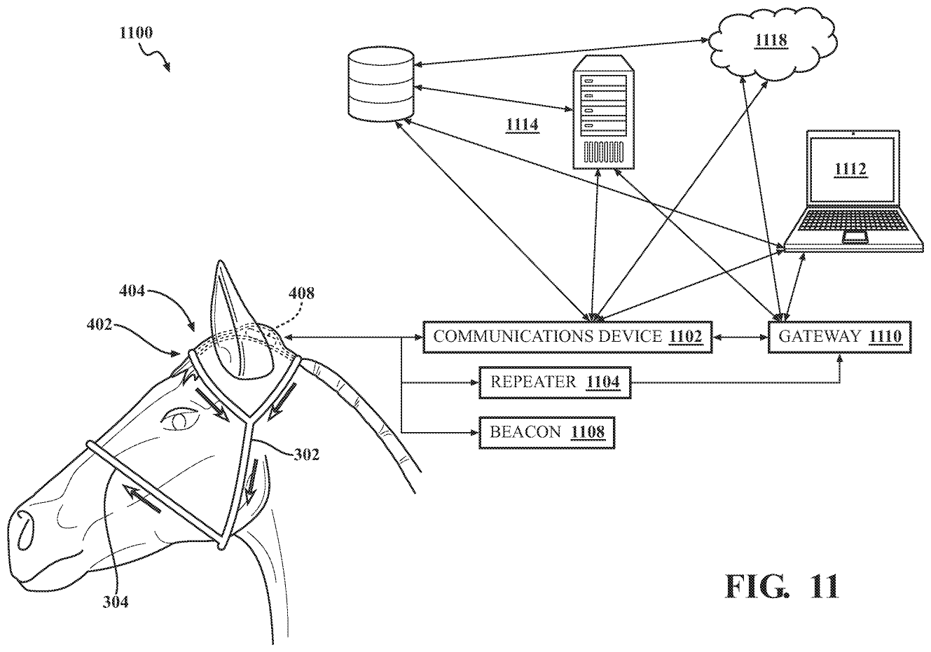

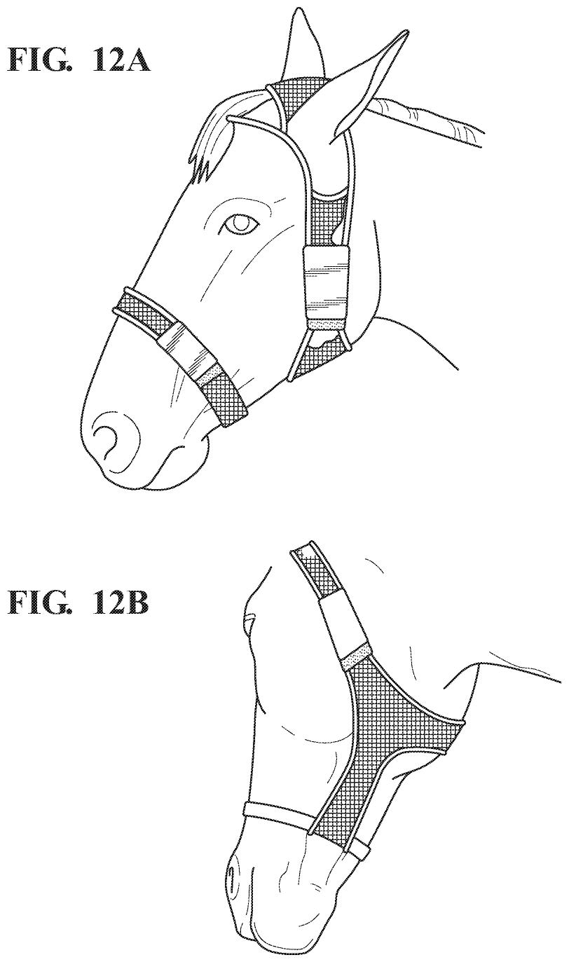

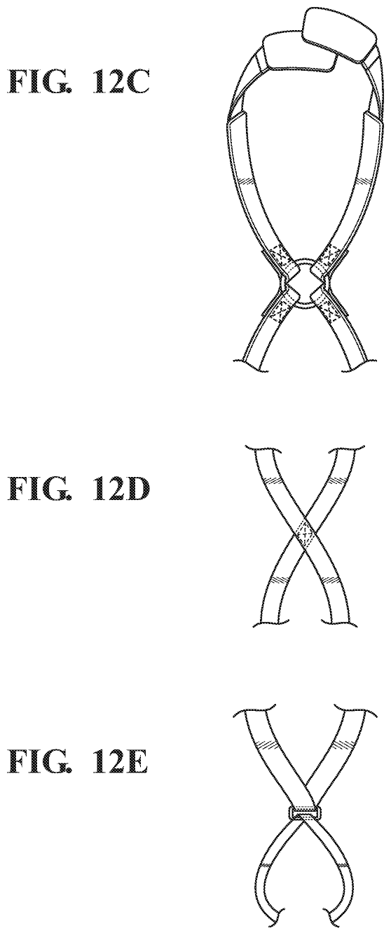

Unlike a halter, such as the one shown in FIG. 1, which requires multiple cross members, the nose strap 304 need not maintain circular contact around the narrow part of the face and can be connected to the headband at a single point 314 beneath the chin. FIG. 12A depicts an embodiment of the headband whose underside is shown in FIG. 12B. In this embodiment, the connection member 1210 between the nose portion and the head portion of the headband is shown as a piece of mesh spanning edge members. In other embodiments, such as those depicted in FIG. 12C, the connection member 1210 may be an O-ring connection 1202, an X-connection 1204 tacked at the center, a double “V” connection 1208, optionally with a loop ring, which allows for different webbing widths and different angles from head to muzzle, and the like. In other embodiments, such as those depicted in FIG. 8A, additional material may be added for aesthetic, comfort or usability reasons, while providing the same function.

Any portion of the headband may comprise one or more attachment elements 802. Such attachment elements ensure safety by allowing for breakaway of the headband, facilitate sizing the headband on differently sized animals, and facilitate removably positioning the headband by a handler located on one or either side of the horse.

This nose strap 304 may be substantially elliptical in shape and held in some tension across the jaw and across the face, between the eyes and muzzle. The tension of the nose strap 304 may be transferred to the headband 302 as the headband is pulled forward onto the wider portion of the jaw, maintaining a more consistent tension in the Tag suspension system, or head portion including tag positioning member, over a wide variety of horse proportions and motions, and keeping the headband 302 from sliding back on the horse's head towards the throat, where it may cause discomfort.

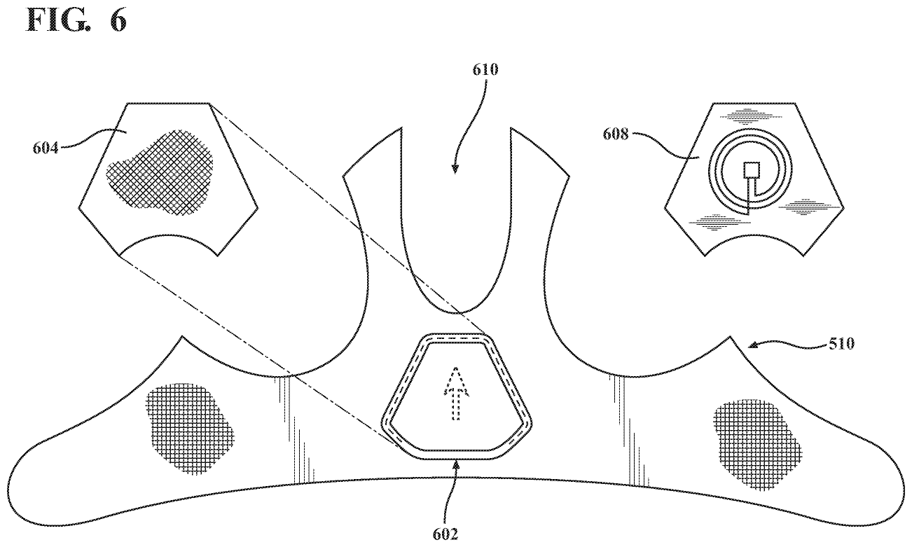

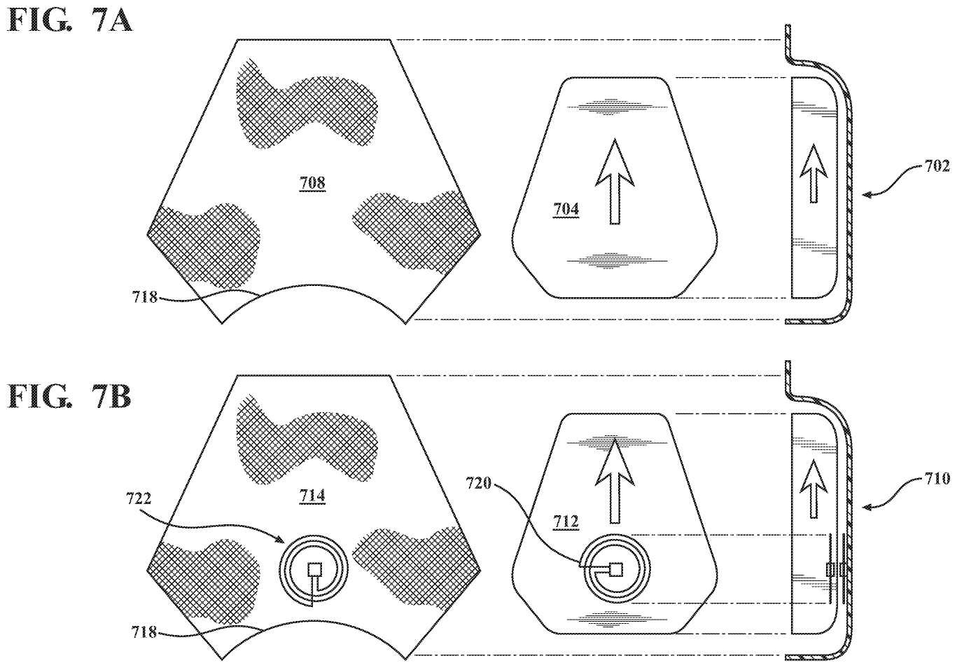

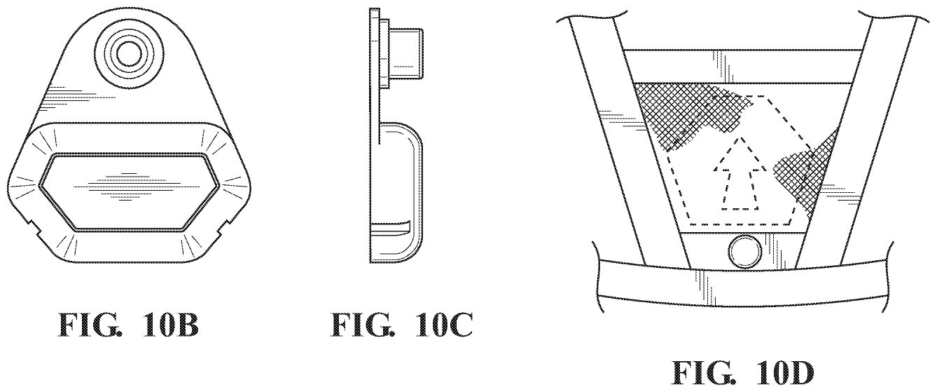

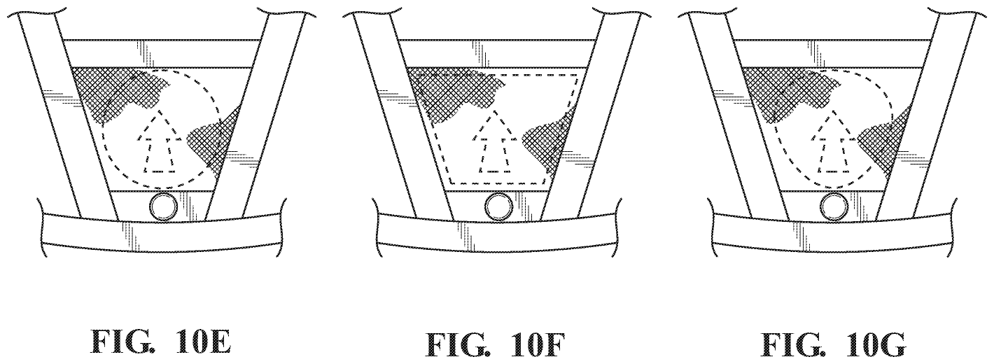

Referring to FIG. 5, FIG. 6, FIG. 7, FIG. 10D, FIG. 10E, FIG. 10F, and FIG. 10G, in some embodiments, the Tag may be inserted into a pocket 502, 602 near the top of the headband. The pocket 502, 602 may be formed or sewn with darts such that it conforms to the Tag. The pocket 502, 602 may have an elastic opening somewhat smaller than the maximum width of the Tag. The Tag may be easily inserted when the pocket 502, 602 is in a neutral condition, but once under the tension of the headband, the pocket corners near the opening may be pulled against the horse's head preventing inadvertent ejection of the Tag. In some embodiments, additional fasteners (e.g., buttons, hook-and-loop fasteners, zipper, snaps, magnets, etc.) may provide additional assurance. In some embodiments, instead of a pocket 502, 602, the tag may be secured to the member by other mechanical means, such as a strap or elastic across the top of tag.

In some embodiments, instead of a pocket 502, 602, the tag itself may have means to associate with the headband in a secure manner. For example, the tag may have a magnetic portion, either through association or as part of the tag, and the tag positioning member 510 may also include a magnetic portion. In another example, the tag and tag positioning member 510 may have opposing portions of a hook-and-loop fastener or a snap. In another example the tag and tag positioning member may be connected using releasable or replaceable fasteners. In another example the tag and tag positioning member may be connected by a latch.

In some embodiments, the tag positioning member 510 may be made from the same material as the headband 302, or may be a different material. Materials may include leather, fabric, foam, webbing (e.g. nylon bands, elastomeric bands, polyester yarns, ribbons, cords, thermoplastic bands, etc.), flexible plastic or composite, polymeric material, or faux or natural animal skin/fur onto which the pocket is formed, sewn, adhered, attached, or otherwise associated. The tag positioning member 510 may be affixed to or associated with the headband by any known means, such as sewing, adhesive, hook-and-loop fastener, or the like. In some embodiments, the tag positioning member 510 may have an opening positioned below where the tag is placed to allow contact between the tag and the horse's head. This may enable certain sensor measurements that benefit from contact or proximity, such as skin temperature or other measurements made by a sensor with a thermally- or electrically-conductive surface or a non-contact sensor such as an infrared thermopile.

Continuing to refer to FIG. 5, FIG. 6 and FIG. 7, in some embodiments, the pocket and Tag shape may be asymmetric to help ensure the Tag is inserted only in the intended direction. The Tag may be narrower at the insertion end to help expand the small elastic opening. The opposite end of the Tag may be wider to help with retention. The wider end may prevent full engagement of a Tag inadvertently inserted backwards.

Referring to FIG. 4 and FIG. 5, the Tag mounting location, centered on and slightly behind the horse's ears presents an optimal RF line of sight to the surrounding areas, both with the horse's head erect and when down, for example when grazing.

As shown in FIG. 6, the pattern of the tag positioning member 510 may include a forelock opening 610. In some embodiments, the pouch 602 may have a pouch top without RFID 604, while in other embodiments the pouch 602 has a pouch top with RFID 608.

Referring to FIG. 7A, a side view 702 of the tag 704 inserted into the pouch 708 is shown. An edge 718 of the pouch 708 may be elastic to facilitate securing the tag 704 in the pouch 708.

Referring to FIG. 7B, a side view 710 of the tag 712 inserted into the pouch 714 is shown. An edge 718 of the pouch 714 may be elastic to facilitate securing the tag 712 in the pouch 708. In an embodiment, the Tag 712 may include an RFID device 720 which can be read by another device. This RFID device 720 could be used with an external device to exchange information or to configure Tag settings, as described in US 2019/0380311, previously incorporated by reference. In an embodiment, the pouch 714 may include an RFID device 722, 608. This RFID device 722, 608 may be read by another device. This RFID device 722, 608 could be used with an external device to exchange information about the animal, headband, or mounting location.

Referring to FIG. 7B, in some embodiments, both the Tag 712 and the headband may include RFID devices 720, 722 which may be positioned such that they can be read simultaneously by a third device, for example to associate or configure a Tag with a specific headband, and by extension, associate the Tag with a specific animal and mounting location, as described in US 2019/0380311, previously incorporated by reference. Alignment of the RFID devices may permit simultaneous reading (excitation) with an external device (RFID Reader/Writer). While the RFID device 722, 608 is shown in association with the pouch, it should be understood that the RFID device 722, 608 can be located anywhere on the headband 302.

FIGS. 8A and 8B depict several views of an embodiment of the headband. In FIG. 8A, the strap has a first side 814 extending under and around the rear, emerging as the second side 812, of the jawbone and includes an attachment element or closure 802, such as a hook-and-loop fastener, to secure to the front member 808 and rear member 804. The nose strap 810 includes an additional cushioning element and may also include a closure 802. FIG. 8B is an enlarged view of the strap 814 and closure 802. In embodiments, only one side of the headband is configured with a strap closure 802, while in other embodiments, the headband may be two or more pieces such that the straps 812, 814 attach the nose strap 810 portion of the headband to the portion with the front member 808 and rear member 804. In some embodiments, the nose strap 810 may be a single piece, the straps 812, 814 may be a single piece, and the head portion including front member 808 and rear member 804 may be a single piece. Each of these pieces may connect one to another such as through one or more attachment elements 802. Whether the headband is a unitary piece, comprised of two portions, or comprised of a plurality of portions, the attachment elements 802 may increase safety by allowing for breakaway of the headband, facilitate sizing the headband on differently sized animals, and facilitate removably positioning the headband by a handler located on one or either side of the horse.

In some embodiments, the headband is a unitary article that does not require a closure 802. In these embodiments, the headband may be somewhat elastic to stretch for positioning on the horse's head, and maintain position with elastic force.

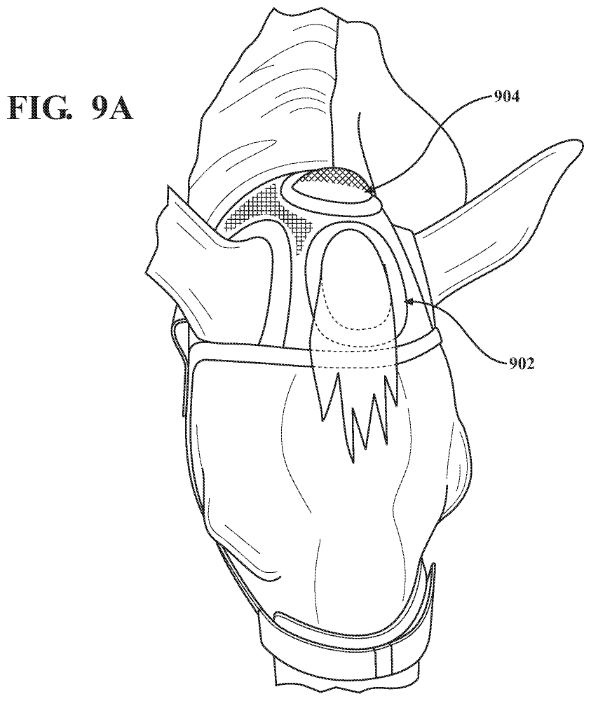

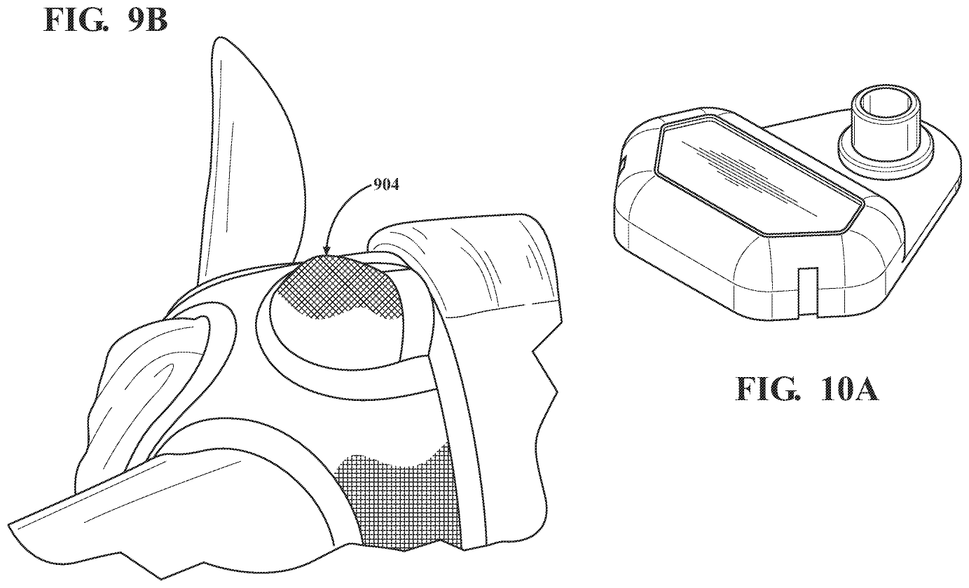

FIGS. 9A and 9B depict several views of an embodiment of the headband with a round tag 904 and a forelock opening 902.

FIGS. 10A, 10B, 10C, 10D, 10E, 10F, and 10G depict several views of an embodiment of the tag. FIG. 10A is an isometric view of the tag, FIG. 10B is a top down view of the tag, FIG. 10C is a side view of the tag, and FIG. 10D depicts the orientation of insertion of the wide end of the tag through the narrow end of the pouch. FIG. 10E depicts a circular shape. FIG. 10F depicts a trapezoidal shape. FIG. 10G depicts an egg/oval shape. While these figures depict variously shaped tags, it should be understood that the tag can be of any shape.

Referring now to FIG. 11, the tag 408 and headband 302 may form a portion of an animal monitoring system 1100. In an embodiment, the tag 408, which may be associated with the headband 302 or other mount, may be in communication with one or more repeaters 1104, other tags 408, beacons 1108, and/or communication devices 1102 which communicate directly, or interact with gateways 1110 to communicate, with a processor 1112, remote server 1114, or the cloud 1118.

References to communication devices 1102 are meant to encompass smart phones, tablets or other similar devices, and the terms may be used interchangeably. References to a processor are meant to encompass one or more processors or processing units. A processor programmed to perform the functionality herein may be located remotely. In embodiments, the processor may be located in any one of the components of described herein including but not limited to gateways, mounts, headbands, beacons, tags, mobile devices, communications devices, sensors, nodes, and radio devices. References to a remote server 1114 should not be considered limiting and may include a plurality of processors, a plurality of servers, a cloud computing platform, or cloud computing-based services. A remote server 1114 may interface with a database 1120, artificial intelligence and/or machine learning platforms. The database 1120 may have information including data about an association between an individual headband 302 and a tag 408 and physical, positional and behavioral data associated with the individual animal.

In some embodiments, the communications device 1102 can be positioned in the headband 302. In some embodiments, the tag 408 and communications device 1102 may be combined into a single, multi-functional device that can be positioned in the headband. In some embodiments, the communications device 1102 positioned in the headband 302, either standalone or as integrated with the tag, may be powered by a battery, or may be powered by a solar cell also positioned on the horse or in the headband.

In an embodiment, such as that depicted in FIG. 8A, the horse headband includes a nose bridge portion 810 configured to span a bridge of a nose of a horse and encircle the nose. A first elongated portion 814 extends transversely along a first side of the nose, wherein the first elongated portion 814 extends from the nose bridge portion 810 below a jaw of the horse to a first trailing edge of the jaw. A second elongated portion 812 extends transversely along a second side of the nose, wherein the second elongated portion 812 extends from the nose bridge portion 810 below a jaw of the horse to a second trailing edge of the jaw. The head portion includes a front member 808, a rear member 804, and a tag positioning member 510, all of which may be flexible. The front member 808 is positioned across a front of a horse's ears, the rear member 804 is positioned behind the ears, and the tag positioning member 510 is attached to the front member and the rear member and configured to receive a tag while avoiding contact with a forelock of the horse, such as with a forelock opening 902, and at least one ear of the horse. An attachment element 802 is configured to attach an end of at least one of the first elongated portion 814 or the second elongated portion 812 to the head portion. In this embodiment, the headband can be a continuous piece of material such as the front and rear members continue on from one or both of the elongated portions. An attachment element 802, such as a hook-and-loop fastener, a snap, a clasp, a tie, a magnet, or a buckle, can be used to attach the head portion to the elongated members 812, 814, or the attachment element 802 may be located elsewhere to join discontinuous segments of members making up the headband.

In an embodiment, such as that depicted in FIG. 4, a horse headband may include a nose bridge member 304 configured to span a bridge of a nose of a horse and encircle the nose. A first elongated member, or jaw piece, 312 may extend transversely along a first side of the nose, wherein a first end of the first elongated member is connected to the nose bridge member 304 at a connection point beneath a chin of the horse. A second elongated member may extend transversely along a second side of the nose, wherein a first end of the second elongated member is connected to the nose bridge member 304 at the connection point beneath the chin. A front member 310 and a rear member 308 bifurcate from a second end of the first elongated member 312 and a second end of the second elongated member, wherein the front member 310 is connected on a first end to the second end of the first elongated member 312 and is connected on a second end to the second end of the second elongated member, and wherein the front member 310 is positioned across the forehead of a horse, in front of the ears. The rear member 308 is connected on a first end to the second end of the first elongated member 312 and is connected on a second end to the second end of the second elongated member, and wherein the rear member 308 is positioned across the rear of a horse's head, behind the ears. A tag positioning member 410 is attached to the front member 310 and the rear member 308, wherein the tag positioning member 410 is configured to receive a tag while avoiding contact with a forelock 402 of the horse and at least one ear of the horse. At least one of the first elongated member 312 or the second elongated member may include a removable connection element so that the horse headband can be removably positioned on a head of the horse. The removable connection element may be positioned to connect distinct portions of the at least one of the first elongated member 312 or the second elongated member. The removable connection element may be positioned to connect the at least one of the first elongated member 312 or the second elongated member to at least one of the first ends of the front member 310 and rear member 308, or the second ends of the front member 310 and rear member 308.

In other embodiments, the headband may include a nose bridge member 304 configured to span a bridge of a nose of a horse, a connection member 314 extending from the nose bridge member at a connection point beneath a jaw of the horse, a head portion 500, and a jaw piece 312. The connection member 314 may be of any size to span from the nose bridge member to the jaw piece 312, which may be attached to the head portion 500. In some embodiments, the jaw piece 312 may be part of the head portion 500 and may appear as elements that extend to below the jaw and approach the nose bridge member such that the connection member can be quite small, and in some embodiments, may just be an attachment element. In some embodiments, the head portion 500 does not have elements that extend such that the connection member 314 includes the jaw piece 312, which is long enough to span from the nose bridge member up to the head portion 500. In some embodiments, the connection member 314 may bifurcate to a first end and a second end, and at least one of the first end or the second end of the connection member 314 may be releasably attached to jaw piece 312 with one or more attachment elements 802. The head portion 500 may include a front member 310 and a rear member 308, wherein the front member is positioned across the forehead of a horse, in front of the ears, and wherein the rear member is positioned across the rear of a horse's head, behind the ears. The head portion 500 may also include a tag positioning member 510 attached to the front member 310 and the rear member 308, wherein the tag positioning member 510 is configured to receive a tag while avoiding contact with a forelock of the horse and at least one ear of the horse. At least one of the nose bridge member 304, jaw piece 312, or the connection member 314 may include one or more attachment elements 802. The one or more attachment elements 802 may be positioned to connect distinct portions of the at least one of the nose bridge member or the connection member. The front member and the rear member may be joined on at least one end. In embodiments, the front member and the rear member are joined on both ends. At the connected ends of the front member and rear member, attachment elements may be disposed, or there may be a portion of material extending from the connected end that may have the attachment element disposed on an end. An angle of the nose bridge member laying on the bridge of the nose may define a position of the connection point beneath the jaw. A tension applied by the connection member 314 between the nose bridge member 304 and the jaw piece 312/head portion 500 may prevent the horse headband from slipping back on the jaw towards the horse's throat. A tension applied by the connection member 314 between the nose bridge member 304 and the jaw piece 312/head portion 500 may pull the horse headband toward a larger circumference of the jaw.

The tag positioning member may include one or more of leather, fabric, foam, webbing, nylon bands, elastomeric bands, polyester yarns, ribbons, cords, thermoplastic bands, flexible plastic, composite material, polymeric material, faux or natural animal skin, or faux or natural fur. The tag positioning member may have an opening to allow contact of at least a portion of the tag with a head of the horse.

A securing member may keep the tag in position on the tag positioning member, such as a pouch top made from material formed on or sewn onto the tag positioning member. Securing the tag may be done by a fastener, a strap or an elastic attached to the tag positioning member, or attached/associated with the tag itself.

An RFID device may be disposed on a portion of the horse headband, such as in or on the securing member or the tag positioning member, or elsewhere on the headband, or the RFID device may be disposed in or on the tag. The RFID device on the tag may be configured to align with an RFID device disposed on a portion of the horse headband.

The tag may have a concave lower surface adapted to be positioned against a surface of a head of the horse along a convex portion, and it may be narrower than the distance between a horse's ears. The tag may include a sensor that collects data relating to at least one of a physiological, behavioral, or an environmental condition.

The headband may include a communications device positioned in the horse headband that wirelessly communicates data from the tag.

The headband may include a processor positioned in the horse headband in electrical communication with the tag for converting at least one data point collected by the tag into at least one of a physiological, behavioral, or an environmental status output data. A communications device in electrical communication with the processor, either in the headband or separate from the headband, may communicate the at least one physiological or environmental status output data, such as to a user, remote server, a mobile device, or the cloud.

In an embodiment of the equine headband, a fabric portion's position may be substantially constrained at a trailing edge of a jaw of a horse by a nose strap resting on the face of the horse, between the eyes and muzzle. A tag may be positioned by the equine headband on a head of the horse, avoiding a forelock and at least one ear of the horse, wherein a tension in a nosepiece portion of the equine headband is translated to a tension in a head portion of the equine headband which serves to pull the tag into contact with the head just behind a poll of the horse. The tag may be positioned in a pouch section of the equine headband. The pouch section may further include at least one feature to locate and retain the tag in a correct orientation. The tag may further include an embedded RFID device. The pouch section may further include an embedded RFID device.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions, and the like. The processor may be or may include a signal processor, digital processor, embedded processor, microprocessor, or any variant such as a co-processor (math co-processor, graphic co-processor, communication co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions, and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions, and programs as described herein and elsewhere. The processor may access a non-transitory storage medium through an interface that may store methods, codes, and instructions as described herein and elsewhere. The storage medium associated with the processor for storing methods, programs, codes, program instructions, or other type of instructions capable of being executed by the computing or processing device may include but may not be limited to one or more of a CD-ROM, DVD, memory, hard disk, flash drive, RAM, ROM, cache, and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code, and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client, and other variants such as secondary client, host client, distributed client, and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of a program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code, and/or instructions. A central repository may provide program instructions to be executed on different devices. In this implementation, the remote repository may act as a storage medium for program code, instructions, and programs.

In embodiments, one or more of the controllers, circuits, systems, data collectors, storage systems, network elements, or the like as described throughout this disclosure may be embodied in or on an integrated circuit, such as an analog, digital, or mixed signal circuit, such as a microprocessor, a programmable logic controller, an application-specific integrated circuit, a field programmable gate array, or other circuit, such as embodied on one or more chips disposed on one or more circuit boards, such as to provide in hardware (with potentially accelerated speed, energy performance, input-output performance, or the like) one or more of the functions described herein. This may include setting up circuits with up to billions of logic gates, flip-flops, multiplexers, and other circuits in a small space, facilitating high speed processing, low power dissipation, and reduced manufacturing cost compared with board-level integration. In embodiments, a digital IC, typically a microprocessor, digital signal processor, microcontroller, or the like may use Boolean algebra to process digital signals to embody complex logic, such as involved in the circuits, controllers, and other systems described herein. In embodiments, a data collector, an expert system, a storage system, or the like may be embodied as a digital integrated circuit (“IC”), such as a logic IC, memory chip, interface IC (e.g., a level shifter, a serializer, a deserializer, and the like), a power management IC and/or a programmable device; an analog integrated circuit, such as a linear IC, RF IC, or the like, or a mixed signal IC, such as a data acquisition IC (including A/D converters, D/A converter, digital potentiometers) and/or a clock/timing IC.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements. The methods and systems described herein may be configured for use with any kind of private, community, or hybrid cloud computing network or cloud computing environment, including those which involve features of software as a service (“SaaS”), platform as a service (“PaaS”), and/or infrastructure as a service (“IaaS”).

The methods, program codes, and instructions described herein and elsewhere may be implemented on a cellular network having multiple cells. The cellular network may either be frequency division multiple access (“FDMA”) network or code division multiple access (“CDMA”) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (“RAM”); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the Figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure, and does not pose a limitation on the scope of the disclosure unless otherwise claimed. No language in the specification should be construed as indicating any non-claimed element as essential to the practice of the disclosure.

While the foregoing written description enables one skilled in the art to make and use what is considered presently to be the best mode thereof, those skilled in the art will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

Any element in a claim that does not explicitly state “means for” performing a specified function, or “step for” performing a specified function, is not to be interpreted as a “means” or “step” clause as specified in 35 U.S.C. § 112(f). In particular, any use of “step of” in the claims is not intended to invoke the provision of 35 U.S.C. § 112(f).

Persons skilled in the art may appreciate that numerous design configurations may be possible to enjoy the functional benefits of the inventive systems. Thus, given the wide variety of configurations and arrangements of embodiments of the present disclosure, the scope of the disclosure is reflected by the breadth of the claims below rather than narrowed by the embodiments described above.

1. A horse headband, comprising:
a nose bridge member configured to span a bridge of a nose of a horse;
a connection member connected to the nose bridge member at a connection point beneath a jaw of the horse;
at least one jaw member, attached to the connection member, and positioned around a trailing edge of a horse's jaw; and
a head portion, attached to the at least one jaw member, comprising:
a front member and a rear member,
wherein the front member is positioned across a front of a horse's ears, and
wherein the rear member is positioned across a rear of a horse's ears; and
a tag positioning member attached to the front member and the rear member, wherein the tag positioning member is configured to receive a tag while avoiding contact with a forelock of the horse and at least one ear of the horse,
wherein the connection member is configured to connect the nose bridge member to the at least one jaw member at the connection point.

2. The horse headband of claim 1, wherein the connection member bifurcates to a first end and a second end, and at least one of the first end or the second end is releasably attached to the at least one jaw member with an attachment element.

3. The horse headband of claim 1, wherein the connection member is an attachment element.

4. The horse headband of claim 1, wherein at least one of the nose bridge member, the at least one jaw member, or the head portion comprises one or more attachment elements.

5. The horse headband of claim 4, wherein the one or more attachment elements are positioned to connect distinct portions of the at least one of the nose bridge member the at least one jaw member, or the head portion.

6. The horse headband of claim 1, wherein an angle of the nose bridge member laying on the bridge of the nose defines a position of the connection point beneath the jaw.

7. The horse headband of claim 1, wherein a tension applied by the connection member between the nose bridge member and the at least one jaw member prevents the horse headband from slipping back on the jaw towards a throat.

8. The horse headband of claim 1, wherein a tension applied by the connection member between the nose bridge member and the at least one jaw member pulls the horse headband toward a larger circumference of the jaw.

9. The horse headband of claim 1, wherein the tag positioning member comprises at least one of the group of materials consisting of: leather, fabric, foam, webbing, nylon bands, elastomeric bands, polyester yarns, ribbons, cords, thermoplastic bands, flexible plastic, composite material, polymeric material, faux or natural animal skin, or faux or natural fur.

10. The horse headband of claim 1, further comprising a securing member that engages the tag to keep it in position on the tag positioning member.

11. The horse headband of claim 10, wherein the securing member is a piece of material sewn onto or a part of the tag positioning member, wherein a pouch is formed in a space between the securing member and tag positioning member sized to receive the tag.

12. The horse headband of claim 10, wherein the securing member is at least one of a fastener, a strap or an elastic attached to the tag positioning member.

13. The horse headband of claim 10, wherein the securing member is attached or associated with the tag itself.

14. The horse headband of claim 1, further comprising, an RFID device disposed on a portion of the horse headband.

15. The horse headband of claim 14, wherein the portion of the horse headband is at least one of a securing member or the tag positioning member.

16. The horse headband of claim 1, further comprising, an RFID device disposed on the tag.

17. The horse headband of claim 16, wherein the RFID device on the tag is configured to align with an RFID device disposed on a portion of the horse headband.

18. (canceled)

19. The horse headband of claim 1, wherein the tag comprises a sensor that collects data relating to at least one of a physiological or an environmental condition.

20. The horse headband of claim 1, wherein the tag positioning member has an opening to allow for at least one of contact-sensing or non-contact sensing of the horse.

21. (canceled)

22. The horse headband of claim 1, further comprising a communications device positioned in the horse headband that wirelessly communicates data from the tag.

23.-72. (canceled)
